(19) United States
(12) Patent Application Publication
(10) Pub. No.: US 2017/0213159 A1
(43) Pub. Date: Jul. 27, 2017

(54) REVENUE MANAGEMENT WILLINGNESS TO PAY HIGHER FARES INDICATOR

(71) Applicant: Gert-Willem Hartmans, Almhult (SE)

(72) Inventor: Gert-Willem Hartmans, Almhult (SE)

(21) Appl. No.: 15/006,015

(22) Filed: Jan. 25, 2016

(51) Int. Cl. G06Q 10/02; G06Q 50/14; G06Q 50/12

(52) U.S. Cl. CPC G06Q 10/02; G06Q 50/12; G06Q 50/14

(57) ABSTRACT

This invention of a revenue management willingness to pay higher fares indicator, provides a method to define in a computer based revenue management system, levels of willingness to pay higher fares, used to improve the forecasting of potential revenue and improve the availability controls defined by the revenue management system. Where current revenue management systems use booked fare class information as basis for forecasting revenue, when demand with a higher willingness to pay higher fares books in a low fare class, this information is not recognized as only the (lower) booked fare class information is stored and used.

The method proposed defines levels of willingness to pay higher fares based on booking record characteristics without directly using the actual booked fare class and storing this information for usage in further steps in forecasting and defining availability controls by the revenue management system.

### CROSS REFERENCE TO RELATED APPLICATIONS

Not applicable.

### BACKGROUND OF THE INVENTION

1. Field of the Invention

The invention relates to the revenue management process for airlines in which a computer based revenue management system provides availability control settings to a computer based reservation system for availability control of different fare levels.

2. Prior Art

In the prior art, it is common in revenue management systems to base the potential revenue value of historic reservation records on the fare class booked and use this in forecasting and optimization to define protection levels for higher fares for revenue management availability controls. When demand books lower fares than their maximum willingness to pay levels, the current methods will not recognize the true revenue potential and availability controls will not be set as optimal as when a better revenue potential estimation would be used.

Consequently, improvements are needed to better estimate the true revenue potential and use these improved inputs for forecasting and optimization to achieve the overall goal of a revenue management system; to maximize revenue.

This invention covers a process for better estimating the true revenue potential of past demand by not using the actually booked fare class but by using other characteristics in the reservation input data defining levels of willingness to pay higher fares, i.e. the high revenue potential based on these characteristics.

Solutions have been proposed in deriving information from the increased bookings in higher classes when lower classes are closed as compared with the bookings in higher classes when lower classes were available. Aside from the fact that this requires historical variation of lower classes being both open and closed, also the fact that bookings in higher classes are to a large extent the result of variation in demand by date i.e. seasonality, makes it difficult to derive full and exact information.

Others have proposed to derive information if a booking is made in the lowest class available or a higher class than the lowest available. This builds on the fact that some product options i.e. fares may have different restrictions, with low fares having more restrictions. For example, if the booking classes are in alphabetical order from higher fares to lower fares with Z as lowest fare and when Z class is available to book but a customer buys class X this is expected to be driven by fare rule restrictions making the lower fare booked in Z-class less attractive for this customer. This method requires fare rules to apply, when removed, it is not possible to apply this method. When classes are closed up to those where no or less restrictions apply, all demand booked in these classes is defined as booking in the lowest, without any differentiation in willingness to pay higher fares.

Various objects, features, aspects, and advantages of the present invention will become more apparent from the following detailed description of preferred embodiments of the invention, along with the accompanying drawings in which like numerals represent like components.

### BRIEF SUMMARY OF THE INVENTION

It is a first objective of the present invention to provide a solution to the problem of identifying willingness to pay higher fares, even if these are booked in low fare classes. Where current revenue management systems use booked fare class as main basis for defining the willingness to pay higher fares, they misrepresent demand that books a low fare class but would be willing to pay a higher fare.

Another objective of the invention is to apply this new information in the process of forecasting, particularly in the forecasting un-constraining step, in the forecast seasonality step and in defining improved forecast outputs used in optimization that better reflects the true revenue potential.

Yet another objective of the invention is the ability to use the new information on willingness to pay higher fares at a detailed level by date and booking lead time to close lower classes directly and achieve higher revenue by these actions.

Other objects and advantages of the present invention will become apparent as a description thereof proceeds.

### BRIEF DESCRIPTION OF THE SEVERAL VIEWS OF THE DRAWING

FIG. 1) Revenue management system context

FIG. 2) Generic revenue management system process

FIG. 3) Willingness to pay higher fare (WTPHF) indicator process

FIG. 4A) Forecast process with class booked

FIG. 4B) Forecast process with willingness to pay higher fare indicator

FIG. 5) Willingness to pay higher fares (WTPHF) closure process

FIG. 6) Willingness to pay higher fares closure process context

### FIG. 1) REVENUE MANAGEMENT SYSTEM CONTEXT

FIG. 1 is a view of the revenue management system context where a revenue management system 1) is used to provide a reservations system 2) with availability control settings. The reservations system 2) provides reservation data 3) to the revenue management system that uses it to generate and send availability control data 4) to the reservations system 2). The data is used by the reservations system 2) to respond to availability/reservation requests 5) with an availability/reservation response 6).

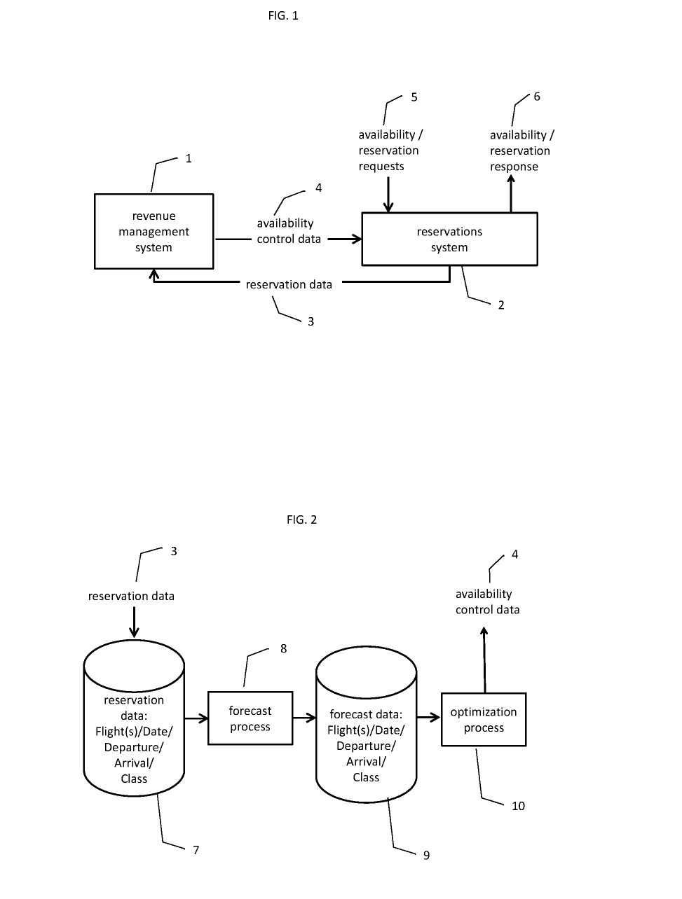

### FIG. 2) GENERIC REVENUE MANAGEMENT SYSTEM PROCESS

FIG. 2 is a view of the generic revenue management system process consisting of storage of reservation data 7) typically for more than a year's history which is used in forecast process 8) that provides a forecast data 9) with demand by booking class 9) which is combined with fares by booking class in an optimization process 10) to provide availability control data 4).

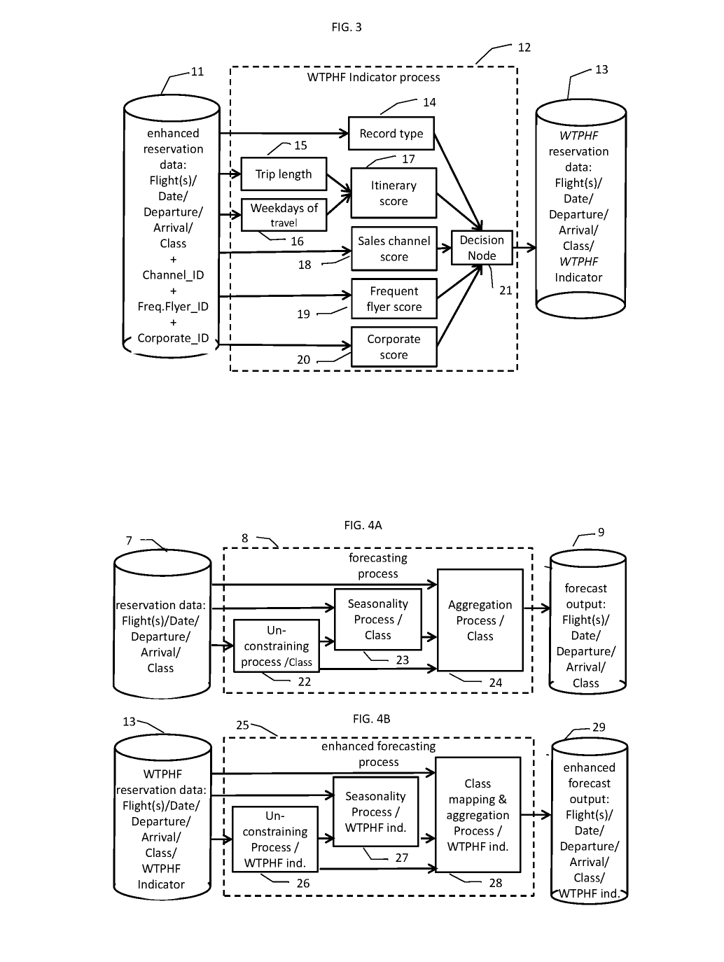

### FIG. 3) WILLINGNESS TO PAY HIGHER FARES (WTPHF) INDICATOR PROCESS

FIG. 3 is a view of a willingness to pay higher fares (WTPHF) indicator process which uses the characteristics of enhanced reservation data 11 that may include the sales channel identifier, and/or frequent flyer identifiers and/or corporate contract/fare information per reservation record. The process uses one of more inputs to define a willingness to pay higher fares indicator and stores the information as WTPHF reservation data 13.

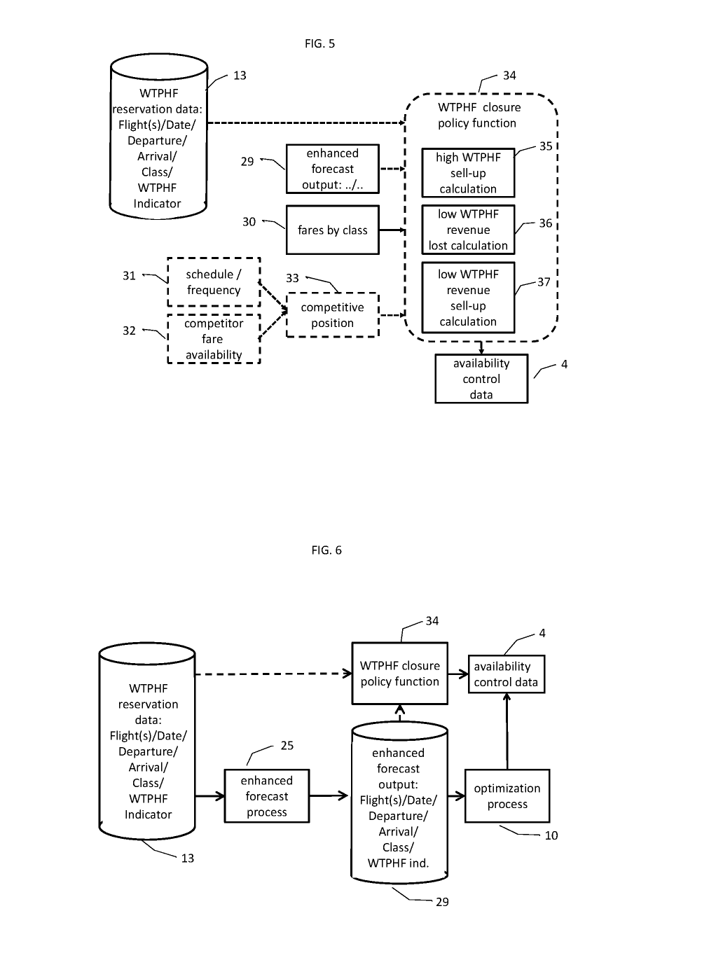

### FIG. 4A) FORECAST PROCESS WITH CLASS BOOKED

FIG. 4A is a view of a generic revenue management system forecast process without a business-leisure indicator which will use input data with class booked for un-constraining process 22, seasonality process 23 and aggregation process 24 providing a demand forecast output 25 at the class booked level.

### FIG. 4B) FORECAST PROCESS WITH WILLINGNESS TO PAY HIGHER FARE INDICATOR

FIG. 4A is a view of an enhanced forecast process 25 which uses willingness to pay higher fare indicator information in the input to the forecast from the enhanced reservation data 13 to enhance at least one of the steps in the forecast process; un-constraining process 26, seasonality process 27, aggregation step 28 and/or to apply class mapping to map bookings in lower classes to higher classes based on the level of willingness to pay identified. The enhanced forecast process 25 provides an enhanced forecast output 29 that better reflects the true potential in willingness to pay higher fares no and can be stored and/or used in the revenue management system 1.

### FIG. 5) WILLINGNESS TO PAY HIGHER FARES CLOSURE PROCESS

FIG. 5 is a view of the willingness to pay higher fares closure process using willingness to pay higher fares (WTPHF) reservation data 13 or an enhanced forecast us output 29 together with fares by class information 30 possibly also information on competitive position 33 based on for example schedule/frequency data 31 and/or competitor fare availability 32 data to provide additional availability controls 4 based on a willingness to pay higher fares closure policy function 34 that calculates optimal settings based on:
revenue gain from demand with a high willingness to pay higher fares to sell-up to a higher fare 35,
revenue lost due demand with low willingness to pay higher fares lost only when higher fares are available 36
revenue from possible sell-up of demand with low willingness to pay higher fares that sell-up to higher fares when lower are not available 37.

### FIG. 6) WILLINGNESS TO PAY HIGHER FARES CLOSURE PROCESS CONTEXT

FIG. 6 is a view of the willingness to pay higher fares closure process context 130 displaying how it can either be fed with WTPHF reservation data 13 or enhanced forecast output 29 and can be used to provide availability control data 4 directly to the reservations system 2 additional to the availability control data provided by optimization process 10.

### DETAILED DESCRIPTION OF THE INVENTION

### 1. Revenue Management Context

This invention pertains to the field of revenue management, particularly to airline revenue management, a process that aims to maximize revenue and/or profits (revenue minus costs) by defining different fare levels for similar products and controlling the availability of the fare levels during the period the product is sellable. For this purpose computer based revenue management systems are used to provide availability controls to a reservation system. Airline revenue management generally aims to take advantage of the differences in demand segments willingness to pay higher fares and their different booking behavior and product preferences. Here an example of segmentation is provides that defines the demand in 2 segments, business and leisure travellers. Below the characteristics assumed to differentiate these segments:

Airline business traveller demand typically will have:
Fixed destination
Fixed date
Fixed departure time preference
Booking lead time starts (late) after decision on trip
Benefit (of trip) outweighs costs

### Airline Leisure Traveller Demand Typically Will be:

Flexible in choice destination*
Flexible in choice date**
Flexible in departure time preference
Flexible in booking lead time (just wait for a low fare, or book further in the future)
   *) except when visiting friends and relatives
   **) except for fixed holidays/events

Both are expected to maximize their product choice preferences in the sense of paying the lowest fare for a product that fits their needs. This in practice leads to the leisure traveller being very price sensitive with a low willingness to pay higher fares and the business traveller to be more price in-elastic, having a higher willingness to pay higher fares. This difference in willingness to pay higher fares and the different booking behavior is one of the reasons that airline revenue management can improve revenue by making different fare options available at different points in time. Fixed capacity constraints with seasonal demand variation being the other major reason different fare availability can improve revenues (vs. one fixed price).

Generally, the input data used in the prior art forecast process 8 uses only the class booked information from the historic data to derive the willingness to pay (higher fares). Information on the different business and leisure segments is not directly available.

As it is more likely that business travellers book higher classes, in the past the class booked information was used to identify the possible demand for higher fares. As business travellers can also book lower classes if available and if the fare rules enable them to do so given their itinerary requirements, information on the true potential business demand is lost in methods used in current revenue management systems.

Having detailed information on willingness to pay higher fares (segments) in the data allows better identification of the different demand patterns and improve revenue results.

### 2. Definitions

The following definitions describe the generic revenue management context.

### Revenue Management System:

A revenue management system 1 is a computer based system that defines availability control data used in the reservation system 2 to control the availability of the fare levels. Generally the revenue management system 1 supports the following process, storing data of which reservation data 3 coming from the reservation system 2), using the data stored in a forecasting process 8 to estimate future demand by fare level that is used in an optimization process 10 to generate the availability control data which is sent to the reservation system 2.

### Reservation System:

A reservation system 2 is a computer based system to support the sales of products. In the case of airlines, the reservation system 2 supports the sales of the seats an airline sells by keeping track of the capacity and seats sold and allowing only sales at the fare levels defined by availability control data 4 settings. In case of hotels, the reservation system 2 supports the sales of rooms that can also be priced differently by date and days before arrival booked. The sales are generally preceded by an availability request 5 to which the system responds with the product and fare options available. If a particular option is chosen by the customer a new request is received to book the specific product to which the system responds with availability/reservation response 6, a confirmation when booked or a rejection if not available anymore.

### Reservation Data:

Reservation data 3 is the information stored in the reservation system 2 reflecting the itinerary and details of a booking. An extract of this information is generally provided to the revenue management system 1 for usage in forecasting. This can be done at various levels of detail depending on the complexity of the revenue management system 1, i.e. for airlines from low level of details as just booking counts per flight/date to sending all booking details including complete origin and destination at more detailed level.

### Booking Class (Class)

Most airline reservation systems use alphanumeric codes (A-Z) to define the fare level associated with a booking, a so called booking class or just class. Fares have a specific booking class and can only be booked if this booking class is currently available i.e. bookable in the reservation system 2.

### Booking Class Availability

The reservation system 2 records booking counts and it controls which fare level will be available at a specific time during the booking window of a flight by defining the booking classes that are bookable, or available, at that time. The settings used by the reservations system 2 to control the availability are often provided by a separate system, the revenue management system 1. The revenue management system 1 generally uses data by class booked for the forecasting process 8, with the classes representing different fare levels. The forecast outputs include the demand by class booked and fares expected for those classes and are used in an optimization process 10 to provide availability control data 4 that are used to control the class availability in the reservation system 2. General objective of the revenue management system 1 will be to protect seats for higher fare class late booking demand. This is done by sending availability control data 4 to the reservation system 2 that closes (make un-available for booking) lower classes when the remaining seats left matches the number of seats needed for higher fare class late booking demand. By closing the lower classes, only the higher classes are available and the higher fares are sold if demand exists that will pay these fares.

### Fare Rules

Fares can have additional rules that the reservation system 2 checks to determine if the specific fare can be booked given the itinerary requested. An example is the minimum stay rule. It can be used to sell a seat to a business traveler planning a short trip at a higher fare and still allow a leisure traveler to book a lower fare on the same flight, when the leisure traveler intends to stay longer. When these fare rules are removed, as often done to match low-cost one-way airline pricing, business travellers can more easily book lower fares. When business travelers book lower fares the class level does not reflect the segmentation business/leisure anymore and revenue management system 1 does not protect for potential demand willing to pay higher fares. This is a major issue for airlines as they aim to remain competitive in pricing options but lose the ability to ensure business segment pays higher fares needed to remain profitable.

### Availability/Reservation Request 5:

To book a seat, first a request is sent to the reservation system to request the available options, the flights and booking class and related fares available for booking. Next one of the options can be selected and a specific booking is made for a specific flight/date/class and the information stored in the reservation system. The availability request message is a message sent to the reservation system expecting to receive a reply with information on the options available.

The reservation request is a message sent to the reservation system requesting to book the specific flight/date/class and expects a message confirming that the seats are booked.

The reservation system 2 will provide a response to availability or reservation requests in the form of the bookable options flights/dates/classes including the number of seats available for the class and in case of a reservation request for a specific flight/date/class a confirmation that the booking has been confirmed, waitlisted or rejected.

### Availability Control Data 6:

Availability control data 4 is output from the revenue management system 1 sent to the reservation system 2 to calculate the availability of flight/date/classes based on business logic combined with the availability control data 4.

### Forecast Process 8:

Forecast process 8 is a revenue management system process that generally provides an ‘un-constrained’ demand by fare level as forecast to be used by the revenue management system optimization process 10) to generate the availability control data 4. Forecast process 8 generally has a step to un-constrain the historic (passenger) demand, un-constraining process 22, a step to define seasonality, the seasonality process 23 used to cluster similar departure dates into so-called seasons and project the unconstrained historic demand data to future departure dates, and an aggregation process 24 which takes the un-constrained demand data and the seasonality definition to provide the forecast output. The forecast process 8 generally also provides the expected value (fare levels) of demand by estimating the expected fare a seat in a specific class will provide on a level of detail so that it can be combined with the demand forecast output. The optimization process 10 requires both demand in number of passengers and the fare levels the demand is willing to pay (either as booking class linked to a fare) or providing fare levels and the demand. The forecast process 8 outputs can be at various levels of complexity but will general be at the flight/date/class level or origin/destination/date/class level with more differentiation possible like point of sale, group/individual etc.

One type of segmentation found in current forecasting process 8 is the differentiation in individual, group passengers and/or non-revenue passengers (staff, frequent flyers redeeming miles). This can be based on a reservation data 3) indicator or in the case of groups, the number of passengers in the reservation record.

### Optimization 10:

Optimization process 10 combines the future scheduled capacity and the forecast output demand both in number of expected customers and expected value of these customers to define availability controls. It can include more business logic and data for example, for airlines to determine cabin configurations and overbooking levels.

### Un-Constraining Process 22:

Un-constraining (also referred to as un-truncating) is the process in the forecast step of a revenue management system that adds demand in the forecast for demand lost due lower class closure rejecting the demand (as the demand did not want to pay more or was lost due it having found a lower fare on an alternative flight) or due demand being rejected due to the flight or cabin being fully booked. As business travellers will not be expected to be rejected if lower classes are closed, but leisure travellers will, having better information on the traveller segment at a detailed level can improve the un-constraining process accuracy.

### Seasonality Process 23:

Within the revenue management system 1, in generating a forecast, seasonality can be a specific process which groups similar dates by expected demand based on date in the calendar. A wide range of methods exist. The historic data from the similar dates are then combined to have a more stable basis for forecasting in what is here called the aggregation process.

As demand varies heavily for the segments business and leisure by date (or season), having the business leisure segmentation information or willingness to pay higher fare information that reflects the business/leisure segmentation, it can be used to create a more accurate seasonality definition.

The resulting seasonality definition is generally used to aggregate the demand in the next forecasting step to reduce error of having sparse data. It also makes it possible to create 2 separate forecasts, one for business demand and one for leisure, providing more detail for next steps.

### Aggregation Process 24:

The historic reservations data by date is used in aggregation process 24 together with the seasonality definition to provide a smoothed demand forecast output used in optimization process 10. Generally the class level demand forecast is combined with the average fare for that class in optimization.

### Class Mapping:

Class mapping is here defined as the process of redefining the class used in the enhanced forecasting process 25 mapping it to a higher class based on demand being identified as having a higher willingness to pay higher fares. This would be generally done in the class mapping & aggregation process/WTPHF ind. 28. When the output of the forecast is a forecast by class, by mapping the demand with higher willingness to pay higher fares that booked in a lower class to a higher class, the forecast will better reflect the actual potential to sell higher fares. When the output of the enhanced forecast process 25 is split in separate forecast by level of willingness to pay higher fares, mapping may not be needed when the next steps can still identify the different segments in the forecast data and use the information to reflect the level of willingness to pay higher fares.

The class/fare levels to which demand with a higher willingness to pay higher fares are mapped may be defined flexibly as fares and class usage change and needs to be aligned to current market circumstances.

Having mapped the business segment to higher classes leads optimization to protect more seats for late booking higher fares and avoids spiral down encountered in general forecasting processes using only historic class booked as input.

### Sell-Up

Sell-up is here defined as the process of closing lower classes to force demand to buy a higher fare other than already protection of late booking high fare demand that the revenue management system already does. Particularly when the protection of a limited share of the seats remaining still allows low fare bookings, sell-up can be applied to close low fare classes to achieve more revenue. A trade-off needs to be made in how much revenue can be gained when low fare classes are closed by sales of higher fare classes against the loss of revenue how much low fare demand may be rejected. Sell-up can build on the differences in type of demand booking by days before departure to only close low classes at the time before departure that more can be gained from demand willing to pay higher fares books. In sell-up the timing of closing lower classes is critical.

Sell-up can differ from the regular process of closing lower classes called protection, where minimum fares levels are set (by closing lower fare classes) to protect seats for later booking higher value demand.

Protection of remaining seats can still leave lower class fares available when the remaining capacity exceeds the protected seats. Sell-up aims to close lower classes at any period in the booking window when higher overall revenue can be achieved from demand being forced to buy a higher fare.

### Closure Policies

Closure policies are here defined as settings added to the availability control data 4 closing lower classes on specific flight(s)/dates at a specific time before departure. A closure policy defines the level of low classes to close and when to close these for a specific flight/date and is applied via availability control data 4.

### 3. Description Invention

The generic airline revenue management system functionality will use the historic data by class booked to forecast demand and not have the ability to identify potential higher willingness to pay when demand with a higher willingness to pay buys low fares and are booked on low fare booking classes.

A revenue management system is meant to provide availability controls to the inventory/reservation system to maximize the revenue from a range of fares offered to have customers pay the maximum they are willing to pay. Where airlines have a mix of business and leisure travellers, business travellers are expected to be less price sensitive, ie. a willingness to pay higher fares. When using past booked data only identifying the class booked, the demand forecast only reflects the actual booking class, driven by lowest class available and fare rule restrictions that may have applied. This leads to under estimating the willingness to pay higher fares and if no fare rules or less effective fare rules apply, a potential spiral down in consecutive updates of the forecast as availability is based on a forecast of low fare bookings only.

In general using historic class booked information in the forecast process leads to under estimating the potential willingness to pay and the revenue management system not serving the aimed for objectives.

To better identify the potential for higher fare demand the solution proposed here identifies at the reservation data level if a record can be classified as having a higher willingness to pay higher fares or not. It can be done using information found in the reservations data to derive the length of the trip, day of week departure/arrival and sales channel, frequent flyer identifier and/or possibly corporate contract information using at least one of these items to define a plurality of levels of willingness to pay higher fares. This can be done in a variety of ways of which one will be described in the preferred embodiment of the invention.

Corporate contract identifier directly identifies the record as a business segment, having an expected higher willingness to pay higher fares. Sales channel and frequent flyer identifier will need further steps to be used as input to determine a level of willingness to pay higher fares. For sales channel this can be done by defining a share of past higher fare class bookings from that sales channel with this percentage used as score to identify sales channels with higher willingness to pay higher fares. The frequent flyer identifier can be linked to information on past frequency of flying or derive the frequency of finding this specific frequent flyer identifier on past reservations data and by directly counting the flights with this identifier.

Record type information will typically provide information if the reservation record is a group booking, a staff booking or a frequent flyer redeeming miles can be used to exclude the records from the process or set them to the lowest level of willingness to pay higher fares.

All the elements, record type, trip length and itinerary, weekdays of travel, sales channel, frequent flyer id and corporate contract information can be used in a heuristic that defines a level of willingness to pay higher fares for that record.

The trip duration in days and weekdays of departure/arrival form important elements in defining the level of willingness to pay higher fares given the differences reflect well the differences in business and leisure segments.

All elements mentioned can receive a score which is used to define the level of willingness to pay higher fares. Various methods can be used to sum or multiple the scores. In preferred embodiment tested the scores are designed to be higher in case the element better fits a business segment (ie. frequent flyer past flight frequency etc.) and the normalized values are summed and compared with a predefined threshold to assign the record as either business or leisure segment.

Having a willingness to pay higher fares indicator (WTPHF) in the reservation data can be used in forecasting and enables better un-constraining, seasonality definition, allows mapping the segment with willingness to pay higher fares to higher booking classes to better reflect the full willingness to pay higher fares (so called class mapping) and/or usage of the indicator in optimization or using it to directly define closure policies by having information on amount of business/leisure segment demand and how many days before departure they book.

### 4. Preferred Embodiment

The preferred embodiment of the process and steps to identify levels of willingness to pay higher fares and apply this in revenue management system is described below:

As first step in the process, (historical reservation) data generally already stored in the revenue management system 1 is used to define a number of scores which are included in a decision node 21 to define a willingness to pay higher fares and the result is stored as indicator for further steps. The preferred embodiment includes the following heuristics which can be adapted to market and pricing structures as required to achieve the best differentiation in levels of willingness to pay higher fares:
If not already available in the data, compute a length of stay at destination; a longer stay reflects a lower willingness to pay higher fares score, here score for trip length 15
Based on market (work weekdays can differ per country) assign a higher willingness to pay higher fares score to arrival days business travellers arrive (Monday-Friday for USA), here score for Weekdays of travel 16
The above scores are combined to a ‘Itinerary score’ 17 reflecting the willingness to pay higher fares based on date characteristics (which can also be retrieved from an availability request)
Airline reservation systems will have a ‘(IATA agent ID) to identify the source of a booking/availability request. Based on historic bookings by the particular ID a score can be given the willingness to pay higher fares possibly based on percentage of past higher fare bookings providing a direct estimate of propensity to pay a higher fare, here named Sales channel score 18
Historic reservation data will also record frequent flyer ID's added to track flight usage to accumulate benefits. These can be used to sum the frequency of past occurrences of the particular ID to reflect the frequency of travel or based on a level coded (Gold, Silver, . . . ) indicate the frequency of travel that again reflects the a willingness to pay higher fares, here named Frequent flyer score 19
A corporate discount scheme that requires a corporate discount ID or specific corporate fare basis to be added in a booking can be used to identify corporate customers who may be expected to have a willingness to pay higher fares (as compared with others and particularly leisure travellers), here named Corporate score 20;

Above mentioned scores can be combined (in a multiplicative or additive form), here in the preferred embodiment are added to provide a value that is compared with a predefined parameter (set based on the score valuation) to best reflect higher willingness to pay (here in 2 categories which reflect business and leisure travellers). This will be done in a decision node 21 that has as output the levels of willingness to pay higher fares. In the preferred embodiment the levels of willingness to pay higher fares are stored as an indicator together with the reservation data as WTPHF reservation data 13. All information is processed in the decision node 21 and as result the level of willingness to pay higher fares is stored for usage in further steps.

Additional feature of airline reservation records is these can have a record type 14 that indicates type of passengers, group versus individuals, frequent flyer using ‘miles’ to travel for free, or airline staff whereby this ‘record type 14’ information. This can be used as information to indicate no or low willingness to pay higher fares.

Example of the method to define 2 levels of willingness to pay higher fares is provided below:
Score categories used are:
Trip length in days {0,1,2,3,4,5,7-14,21}=>score values {0.6,0.6,0.5,0.5,0.4,0.4,0.3,0.0}
Arrival date itinerary {Mon-Fri,Sat,Sun}=>score values {0.2,0.0,0.05}
Agent ID {% bookings high fares in past for the ID}=>sqrt{% bookings higher fares}
Frequent flyer level {Gold,Silver,Base, none}=>score values {0.5,0.4,0.05,0}
Cut-off parameter for high/low willingness to pay: 0.62
Reservation record 1 information:
Trip length in days: 2=>score 0.5
Arrival date itinerary: Mon=>score values 0.2
Agent ID: 15%=>0.38
Frequent flyer level: Silver=>score 0.4
Sum scores: 1.48 compared with threshold 0.62=>HIGH willingness to pay higher fares
Reservation record 2 information:
Trip length in days: 7=>score 0.3
Arrival date itinerary: Sat=>score values 0.0
Agent ID: 1%=>0.01
Frequent flyer level: none=>score 0.0
Sum scores: 0.04 compared with threshold 0.62=>LOW willingness to pay higher fares
In this case with 2 levels of the willingness to pay higher fares data can be stored as 1 for HIGH and 0 for LOW willingness to pay higher fares:
Record 1: 1
Record 2: 0
End of example.

Storing the information on levels of willingness to pay higher fares allows usage in various steps in the enhanced forecast process 25. In the preferred embodiment this is used in the un-constraining process 26, seasonality process 27, class mapping and aggregation process 28 as described below.

Having an indicator of willingness to pay higher fares allows the un-constraining step in the enhanced forecast process 25 to be enhanced by applying differently the booking information with a higher willingness to pay. Where un-constraining aims to identify demand lost due lower classes being closed, demand with a higher willingness to pay 515 higher fares will not be affected and can be excluded from the un-constraining. When un-constraining better reflects the demand with a low willingness to pay higher fares, it can be more accurate.

Having an indicator of willingness to pay higher fares allows the seasonality step in the 520 forecast process to be enhanced by applying differently the booking information with a higher willingness to pay. Where different types of demand like business and leisure have very different seasonality characteristics, by using indicator of willingness to pay higher fares to differentiate demand can improve the seasonality step accuracy by accurately differentiating different segments with different seasonality profiles.

Having an indicator of willingness to pay higher fares allows the forecast aggregation step to be split by the levels of willingness to pay higher fares identified and apply different processes on different levels. Where the class booked will generally still be used to match to the fare and identify a value needed for optimization, it is possible to map demand with a high willingness to pay higher fares to a higher class if booked in a low class. In this way the resulting forecast and optimization outputs will better reflect the true revenue potential. Protection levels set by the revenue management system better protect seats for late booking passengers with a high willingness to pay (so-called sell-up). As the demand in all steps from un-constraining, seasonality and aggregation can benefit from the indicator of willingness to pay higher fares, either by having different processes for each level or using the information to improve the process's effectiveness.

Where current revenue management system 1 optimization 10 outputs only provide (bid-price) protection by reserving the seats required for late booking higher value demand but (depending on the remaining capacity) may still leave lower class fares available, additional process can be used to close the lower classes when this will increase revenue. Here this is the WTPHF closure policy function 34 which makes a trade-off in demand lowest (demand with low willingness to pay higher fares) and gain from demand with a high willingness to pay higher fares that will be forced to book a higher fare class. The competitive position can be taken into account in product (schedule frequency departure times) and/or actual competitor lowest fare availability data (now generally collected via web-scraping).

The WTPHF closure policy function 34 uses either the WTPHF reservation data 13 directly or uses the enhanced forecast output 29 together with fares by class 30 data to define the value of demand. If the preferred embodiment of the invention sums results of 3 calculations; the demand that will sell-up to a higher class, the high WTPHF sell-up calculation 35 being a positive value, the low WTPHF revenue lost calculation 36, being a negative value when demand would be rejected, and the possible positive result of demand that sells-up of low WTPHF revenue sell-up calculation 37. If the sell-up steps are not too large, some demand with a low WTPHF level may still sell-up but this is made dependent on the competitive position 33. The competitive position in turn is based on information available such as schedule/frequency 31 for airlines and competitor availability information 32, now generally collected from web-sites. To define the best closure policy all possible combinations of days before departure and class level to close can be enumerated and the combination with the best revenue potential selected to be applied. This method of using the indicator of willingness to pay higher fares can be set-up as a process that on a very detailed level closes lower classes by product, date and booking lead time. The settings to define which fare or class the demand with a high willingness to pay higher fares will sell-up to, needs to be defined as a input parameter and can differ per market. The output of this process can be included in the revenue management system 1 optimization process 10, or set-up as a separate process that feeds the reservation system with additional controls that are applied on top of the revenue management system availability control inputs as illustrated in FIG. 6.

As such, this invention has been disclosed in terms of preferred embodiments thereof which fulfills each and every one of the objects of the present invention as set forth above and provides new and improved method of defining revenue management system availability controls used in reservation systems.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. A method performed by an electronic data machine (computing device) for categorizing reservation data in different levels of willingness to pay higher fares using the following steps:
Reading said reservation data as input data;
A step with functions to define at least one score reflecting a plurality of levels of willingness to pay higher fares based on said reservation data input comprising:
a score based on duration stay at destination
a score based on weekday of departure
frequent flyer id and associated level reflecting the frequency of past purchases
frequent flyer identification and the frequency of past purchases recorded under this id
corporate contract information
sales channel and a score based on past sales of higher fares by that channel
In case of multiple scores, applying a function to define a single indicator of the willingness to pay higher fares based on said scores;
Storing said indicator of willingness to pay higher fares for further usage

2. The indicator defined in the method of claim 1 further comprising; defining a plurality of levels of willingness to pay higher fares of airline customers based on airline reservation data characteristics other than directly using the historical booked class information.

3. The indicator defined in the method of claim 1 further comprising; storing said indicator together with the said reservation data inputs in the revenue management system.

4. The indicator defined in the method of claim 1 further comprising; calculating on demand when needed in the revenue management system.

5. The indicator defined in the method of claim 1 further comprising; calculating said indicator when needed in a reservations system based on the data items in an availability request.

6. The indicator defined in the method of claim 1 further comprising; applying said indicator in a revenue management system un-constraining process to better identify which reservation records had a higher willingness to pay higher fares and based on this information process the records differently in the un-constraining process.

7. The indicator defined in the method of claim 1 further comprising; applying said indicator in a revenue management system seasonality process to identify different types of demand that have different seasonality and booking behavior and process said demand differently in the seasonality process.

8. The indicator defined in the method of claim 1 further comprising; applying said indicator in a revenue management system forecast process to identify the level of willingness to pay higher fares and using this information to process said records differently in the revenue management system forecast process.

9. The indicator defined in the method of claim 1 further comprising; applying said indicator in a revenue management system forecast process to better identify which reservation records can be categorized as being business travellers and create separate forecasts by business and other demand.

10. The indicator defined in the method of claim 1 further comprising; applying said indicator in a process to identify the reservation data records that have a higher willingness to pay higher fares and can be mapped to a higher class when booked in a lower class for improved identification of high fare potential demand in the revenue management system demand forecast.

11. The indicator defined in the method of claim 1 further comprising; applying said indicator in a process to identify different levels of willingness to pay higher fares and using said indicator as input in the revenue management system optimization process.

12. The indicator defined in the method of claim 1 further comprising; applying said indicator to identify when the share of bookings with a higher willingness to pay higher fares enables closing lower classes to provide a positive result in revenue.

13. The indicator defined in the method of claim 1 further comprising; applying said indicator to define policies that define the number of days before departure to close lower classes.

14. The indicator defined in the method of claim 1 further comprising; using duration so stay at destination as an input for a score used in determining the level of the willingness to pay higher fares defined by said indicator.

15. The indicator defined in the method of claim 1 further comprising; using departure day of week of travel as an input for a score used in determining the level of the willingness to pay higher fares defined by said indicator.

16. The indicator defined in the method of claim 1 further comprising; using frequent flyer identification to reflect the frequency of travel as an input for a score used in determining the level of the willingness to pay higher fares defined by said indicator.

17. The indicator defined in the method of claim 1 further comprising; using corporate contract information stored in the reservation data as an input for a score used in determining the level of the willingness to pay higher fares defined by said indicator.

18. The indicator defined in the method of claim 1 further comprising; using corporate fare base information stored in ticket information and linked to the reservation data as an input for a score used in determining a level of the willingness to pay higher fares defined by said indicator.

19. The indicator defined in the method of claim 1 further comprising; using sales channel information stored in the reservation data as an input for a score used in determining the level of the willingness to pay higher fares defined by said indicator.

20. The indicator defined in the method of claim 1 further comprising; being defined based on information in an availability request and used to determine the levels of willingness to pay higher fares and being directly applied in the determination of the availability response.

21. The indicator defined in the method of claim 1 further comprising; defining a no plurality of levels of willingness to pay higher fares of hotel customers based on hotel reservation data characteristics other than directly using the historical fare level paid information.
